(19) United States
(12) Patent Application Publication
(10) Pub. No.: US 2026/0133088 A1
(43) Pub. Date: May 14, 2026

(54) Dual-Sensor Pressure Measurement System with Tubing Distortion Correction

(71) Applicant: Steven Mark Keeter, NEWPORT NEWS, VA (US)

(72) Inventor: Steven Mark Keeter, NEWPORT NEWS, VA (US)

(21) Appl. No.: 19/220,301

(22) Filed: May 28, 2025

Related U.S. Application Data
(60) Provisional application No. 63/718,031, filed on Nov. 8, 2024.

(51) Int. Cl. G01L 19/00; G01L 27/00

(52) U.S. Cl. CPC G01L 19/0038; G01L 27/005

(57) ABSTRACT

A miniaturized pressure measurement system includes an array of pressure measurement channels, each comprising a digitally compensated pressure sensor coupled to a pressure conduit and a high-speed pressure sensor mounted in intimate physical contact on the sensor housing to ensure aligned, high-bandwidth response for calibration. A signal processor applies a correction algorithm, derived from an impulse response calibration performed using the high-speed pressure sensor, to the measurements from the digitally compensated pressure sensors. This enables dynamic pressure correction across multiple low-bandwidth digital channels. The system supports synchronized, high-fidelity, multi-channel pressure measurements within a compact, scalable architecture.

### FIELD OF THE INVENTION

The present invention relates to pressure measurement systems, and more particularly to a miniaturized, multi-channel system and method for correcting conduit-or tubing-induced pressure distortion using a combination of a high-speed calibration sensor and a digitally compensated pressure sensor within each channel, enabling synchronized, dynamic correction across arrays of high accuracy low-bandwidth measurement channels.

### BACKGROUND

Dynamic pressure measurements acquired through long, narrow tubing or other conduit systems are affected by acoustic filtering, damping, and wave reflections, introducing phase lag, amplitude attenuation, and signal dispersion. Conventional solutions typically either rely on high-bandwidth sensors mounted directly at the measurement site or apply global correction models that lack channel-specific accuracy, making them unsuitable for scalable, multi-channel applications.

Existing multi-channel pressure scanners, such as those offered by Scanivalve Corporation, Kulite Semiconductor Products, Inc., and others often require high-speed sensors on every channel or depend on generalized compensation models that do not account for individual channel differences. These systems typically lack integrated or co-packaged calibration mechanisms and do not support per-channel impulse response characterization or array-20 wide correction derived from empirical measurements.

Notable prior art includes:
Juanarena et al., U.S. Pat. No. 6,105,469—Describes a dynamic pressure calibration system utilizing a reference signal and multiplexed analog transducers but lacks integrated high-speed calibration sensors or per-channel calibration architecture.
Keeter et al., U.S. Pat. No. 5,535,634—Details analog multiplexing techniques for pressure signal conditioning but does not incorporate digital per-channel calibration based on measured transmission path responses.
Gross et al., U.S. Pat. No. 5,251,494—Introduces a pressure scanning system employing microvalves for multiplexing but lacks per-channel signal correction and array-wide synchronized high-speed calibration.
Scanivalve Corp., U.S. Pat. No. 6,230,557—Describes a scanner architecture utilizing analog multiplexing techniques but offers no dynamic compensation derived from empirical impulse response measurements.
Scanivalve DSA5000 Ethernet Pressure Scanner—A commercial 16—channel intelligent pressure scanner offering high-speed, synchronous data acquisition with 24-bit A/D converters, sampling rates up to 5,000 Hz per channel, IEEE1588-2008v2 PTP time synchronization, and an integrated web server for configuration and operation; however, it does not provide per-channel empirical calibration using co-packaged or temporarily coupled high-speed sensors.

None of these systems teach or suggest a scalable, miniaturized, multi-channel pressure measurement architecture in which each low-bandwidth digitally compensated pressure sensor is integrated with or calibrated by a high-speed pressure sensor for deriving an empirical correction algorithm applied on a per-channel basis. Nor do they implement a system where per-channel impulse response characterization leads to real-time compensation of phase and amplitude distortions across synchronized multiport arrays.

Thus, a need exists for a scalable, manufacturable pressure measurement system that integrates high-speed calibration sensors, per-channel empirical calibration, and real-time correction algorithms, enabling accurate, synchronized multi-channel dynamic pressure measurements in a miniaturized array configuration.

### SUMMARY OF THE INVENTION

The present invention provides a miniaturized, scalable, multi-channel pressure measurement system comprising multiple synchronized digitally compensated pressure sensors, each coupled to a pressure conduit and either permanently or temporarily paired with a high-speed calibration pressure sensor. The high-speed sensor is used to perform an empirical impulse response or equivalent calibration of the transmission path, allowing the system to derive a correction algorithm, such as a deconvolution filter or equivalent signal correction approach, to dynamically correct pressure measurements for conduit-induced distortions.

By combining a low-bandwidth, digitally compensated pressure sensor with a high-speed calibration sensor at each measurement channel, the system enables accurate, real-time correction of phase and amplitude errors without requiring continuous high-speed measurement at every port. This architecture supports synchronized operation across large channel arrays, making it uniquely suited for high-fidelity dynamic pressure scanning applications where prior systems fail to provide per-channel calibration or empirical compensation mechanisms.

### BRIEF DESCRIPTION OF THE DRAWINGS

FIG. 1 is an exemplary embodiment of an isometric schematic of a single sensor assembly channel, showing a high-speed calibration pressure sensor mounted onto the lid of a digitally compensated pressure sensor, with a pressure conduit extending for connection through a printed circuit board via.

FIG. 2 is an exemplary embodiment of a flowchart of the conduit-induced distortion correction process, illustrating the calibration and operational measurement paths.

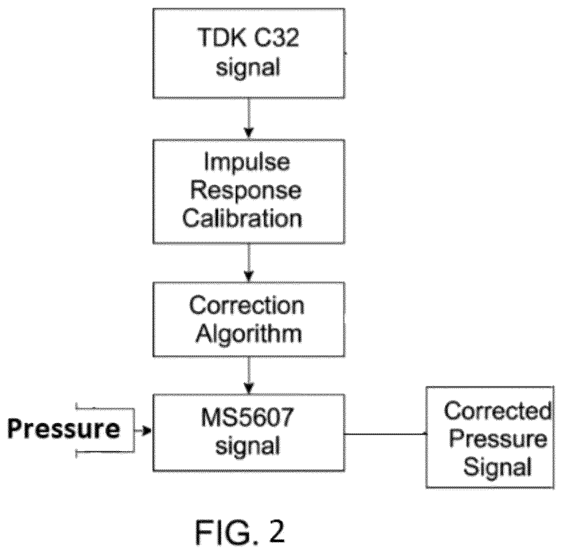

FIG. 3 is an exemplary embodiment of a flowchart illustrating conduit-induced distortion compensation using impulse response modeling and correction algorithms based on acoustic transmission properties.

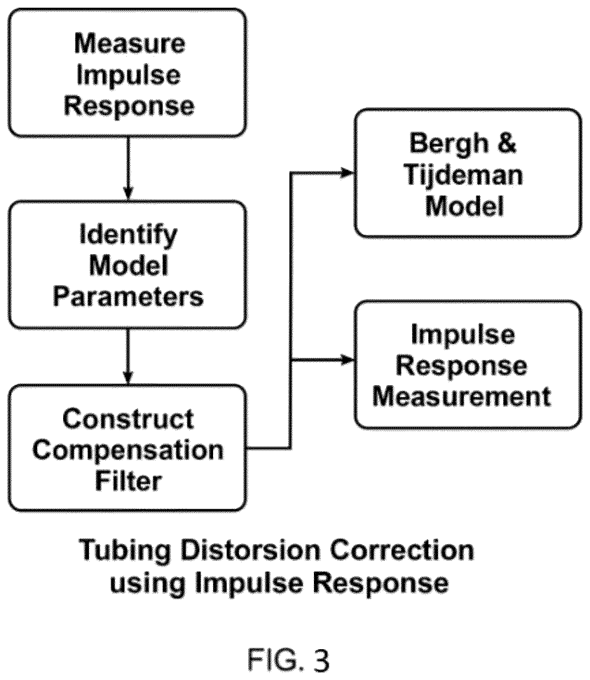

### DETAILED DESCRIPTION

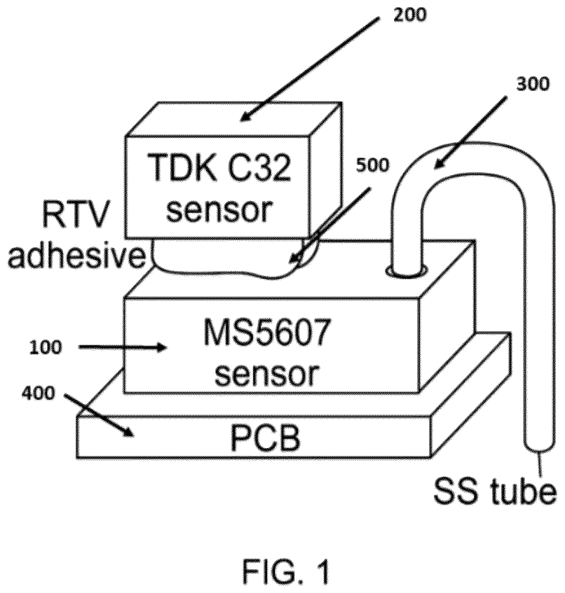

Referring to FIG. 1, the system includes a digitally compensated pressure sensor 100 mounted on a printed circuit board 400. A high-speed calibration pressure sensor 200 is mounted directly onto the housing or lid of the pressure sensor 100 over a first port, sealed to maintain pressure communication across the interface. This intimate physical mounting ensures that the calibration sensor 200 and the digitally compensated pressure sensor 100 experience the same dynamic pressure signal at the same location, allowing the high-speed sensor to capture an aligned, high-bandwidth response that accurately characterizes the transmission path's behavior relative to the measurement sensor.

A pressure conduit 300 is connected to a second port of the housing and extends downward through a via in the printed circuit board 400 to connect to an external pressure source. Pressure enters via conduit 300, filling the internal cavity of the pressure sensor 100 and the underside of the calibration sensor 200. Electrical connections, such as bond wires or surface contacts, couple the calibration sensor 200 to the system electronics (not shown in the figure).

The calibration sensor 200 is sampled during an impulse response calibration process to characterize the pressure transmission path, which includes the conduit, cavity, and sensing interfaces. The resulting calibration data is processed by the signal processor to derive a correction algorithm. During normal operation, only the digitally compensated pressure sensor 100 is used for measurement, with its output processed through the derived correction algorithm to compensate for transmission-induced distortion. This architecture enables multiple synchronized channels, each comprising a low-bandwidth digitally compensated sensor 100, to benefit from a calibration derived from a co-located or temporarily coupled high-speed calibration sensor 200, supporting scalable, high-fidelity, multi-channel pressure measurements without requiring continuous high-speed sensing at each channel.

To correct pressure signal distortion introduced by the conduit system, the system applies a compensation algorithm derived from the measured step or impulse response. This distortion can be modeled as a linear, time-invariant system, where the transmission path behaves like a low-pass filter affecting amplitude and phase. The transfer function may be determined by fitting the measured response to a physical model, such as alternative acoustic or numerical model equations, or by numerically computing the transfer function directly from the impulse response data. A deconvolution filter is constructed by taking frequency-domain or time-domain transforms of the measured response, regularizing and inverting it to form an approximate inverse transfer function. This inverse filter is applied in software to the output signals from the low-bandwidth digitally compensated sensors, correcting for time delay and amplitude attenuation introduced by the pressure transmission path. While acoustic modeling and digital correction techniques are well established in the public domain, the novelty of the present system lies in its multi-channel architecture, per-channel calibration using integrated or temporarily coupled high-speed sensors, and the combination of hardware and software features enabling scalable, synchronized dynamic pressure correction across arrays of miniaturized measurement channels.

In certain embodiments, the high-speed calibration pressure sensor outputs an analog signal that is sampled using an on-board analog-to-digital converter (A/D converter) operating at rates of 10 kHz or greater. This digitization enables the system to capture high-resolution impulse or step response data for characterizing the dynamic behavior of the pressure transmission path. While the calibration sensor is optimized for high-speed, transient response, the low-bandwidth digitally compensated pressure sensor typically provides already-digitized measurements at sampling rates below 2 kHz, focusing on steady-state accuracy. Most, if not all, currently available digitally compensated pressure sensors are designed primarily for steady-state or low-frequency measurements and do not provide measurement or data output rates exceeding approximately 2 kHz. These sensors typically incorporate on-chip signal processing and averaging circuits optimized for accuracy and noise reduction at the expense of high-speed dynamic response. As a result, they are unsuitable for directly capturing fast transient pressure events without correction. By integrating or temporarily coupling a high-speed calibration pressure sensor with significantly higher bandwidth, the present system enables accurate dynamic measurement using these otherwise low-bandwidth digital sensors by applying empirically derived correction algorithms. The combined system thus leverages both high-speed analog sensing with local A/D conversion and low-bandwidth digital sensing to achieve per-channel empirical calibration and real-time correction.

1. A pressure measurement system comprising:
a digitally compensated pressure sensor comprising a housing with a first port and a second port;
a high-speed pressure sensor mounted over the first port and coupled to the housing to seal the interface;
a pressure conduit connected to the second port and extending through a printed circuit board;
and a signal processor configured to apply a correction algorithm to measurements from the digitally compensated pressure sensor, the correction algorithm derived from an impulse response calibration using the high-speed pressure sensor.

2. The system of claim 1, wherein the high-speed pressure sensor comprises a MEMS-based pressure sensor with analog or high-bandwidth output, optionally coupled to an analog-to-digital converter.

3. The system of claim 1, wherein the high-speed pressure sensor has a sampling rate or bandwidth sufficiently exceeding that of the digitally compensated pressure sensor.

4. The system of claim 1, wherein the pressure conduit comprises a rigid or semi-rigid tube extending from the housing to the printed circuit board.

5. The system of claim 1, wherein the correction algorithm comprises a deconvolution filter or equivalent signal correction approach configured to compensate for phase and amplitude distortion caused by the pressure conduit.

6. The system of claim 1, wherein the high-speed pressure sensor is utilized only temporarily for calibration and is inactive or removed during subsequent pressure measurements.

7. A method for measuring pressure in a synchronized multi-channel system, comprising:
mounting a high-speed pressure sensor onto a housing of a digitally compensated pressure sensor over a first port;
sealing the high-speed pressure sensor to the housing;
connecting a pressure conduit to a second port of the housing;
performing an impulse response calibration using the high-speed pressure sensor to characterize the pressure transmission path;
deriving a correction algorithm from the impulse response calibration;
measuring pressure with the digitally compensated pressure sensor; and
applying the correction algorithm to the pressure measurements to compensate for distortion introduced by the pressure conduit.

8. The method of claim 7, wherein the correction algorithm is applied across a plurality of digitally compensated pressure sensors arranged in a synchronized array.

9. The method of claim 7, wherein the high-speed pressure sensor is inactive or removed during pressure measurement following calibration.

10. The method of claim 7, wherein the correction algorithm is implemented in software on the signal processor and applied in real time to the pressure measurements.
